(19) United States
(12) Patent Application Publication
(10) Pub. No.: US 2004/0134510 A1
(43) Pub. Date: Jul. 15, 2004

(54) Gloss and floss

(76) Inventors: Arnold G. van Vilsteren, Newmarket (CA); Elaine C. Tivinsky, Newmarket (CA)

Correspondence Address: ARNOLD G. VAN VILSTEREN, SUITE 102, 20 WILLIAM ROE BLVD., NEWMARKET, ON, L3Y 5V6, CA

(21) Appl. No.: 10/340,143

(22) Filed: Jan. 13, 2003

(51) Int. Cl. A45D 44/18; A61C 15/00

(52) U.S. Cl. 132/309; 132/325

(57) ABSTRACT

A toothbrush having a spool of floss stored within the handle, and a forked floss holding frame for holding a portion of the floss in a taut condition for use thereof. The toothbrush includes a handle which terminates in a floss holding frame across which floss from the spool may be extended and held tight.

### BACKGROUND OF THE INVENTION

Field of the Invention

The present invention relates to dental care devices and more particularly pertains to a toothbrush and dental floss holder having a spool of floss stored within the handle and an arched flossing fork having a pair of spaced arms for holding a portion of the floss in a taut condition for use thereof. The conventional manual dental flossing technique involves winding a length of dental floss around the first finger of each hand, drawing the floss taut between the fingers, and positioning one finger partially in the mouth and the other finger outside the mouth such that the floss can be gently guided between the teeth using the fingers and thumbs. The dental floss is held under tension against the surface of the tooth and guided slightly below the tooth line. A vertical scraping motion is made on the side of each tooth to remove bacterial plaque and food particles lodged between the teeth and under the surface of the gums.

A variety of tools have been devised to assist in the dental flossing process. Typically, they embody means for suspending a short length of dental floss under tension. Heretoforeknown dental flossing tools are intended to aid the user in cleaning difficult to reach teeth. However problems encountered in using such tools or using the manual technique are that the face and lips must often be stretched or distorted significantly to gain access to the tooth target areas where flossing is desired. In addition, heretoforeknown flossing devises tend to obstruct or interfere with viewing of the flossing activity in the target area by the user. Furthermore, such tools tend to interfere with both the tongue and the cheek during flossing. Particularly difficult areas to floss are those between the second bicuspids and the molars in the upper and lower jaw. It is often difficult to apply and control the proper amount of force in the desired direction to achieve flossing activity which satisfactorily cleans the teeth without damaging gingival tissue.

### SUMMARY OF THE INVENTION

The present invention provides a dental flossing tool having a spool of floss stored within the handle, which reduces facial distortion in use and increases the users' visibility of the flossing activity in the target area. The tool promotes ease of access to the target area while minimizing interaction between the flossing activity and the tongue or the cheek. The tool may be operated with the reciprocatory vertical motion similar to that used in brushing the teeth.

The tooth cleaning unit, is of a compact construction, capable of a normal use for brushing teeth, and includes in the handle section thereof a readily accessible supply of dental floss that can be successively withdrawn from the unit and bridged across the forked floss holder having a pair of spaced arms and severed with the recessed metal cutter. The floss cutting member is carried within the confines of the handle section of the cleaning unit so as to eliminate any accidental injury or cutting of fingers in the handling of the cleaning unit, and is capable of readily severing the floss by merely pulling the floss against the cutting section thereof.

Concurrently with the cutting action a leading section of the floss is left exposed at a position to be conveniently gripped for a later withdrawal of a next length of floss from the floss supply in the handle section

### BRIEF DESCRIPTION OF THE DRAWINGS

In drawings which illustrate embodiments of the invention.

FIG. 1. is a top view of this embodiment, showing the full length of the tool, handle with built-in floss container, cutter, and floss dispensing hole and button.

FIG. 2 shows the floss container lid in the open position, a spool of floss in the floss container, the floss dispensing hole, the floss button, and a diagram of how to fasten the floss around the tips of the fork.

FIG. 3 shows the full length of the tool, the brush head, the arched flossing fork, the floss groove/channel, and the notched tips of the fork. And the closed floss container lid.

FIG. 4 shows the full length of the tool, the brush head, the flossing fork, the button, the floss container lid, the empty floss container, and the notches to allow the lid to snap shut.

### DESCRIPTION OF THE PREFERRED EMBODIMENT

With reference now to the drawings and in particular to FIG. 14 and generally designated by the reference numeral 1 will be described.

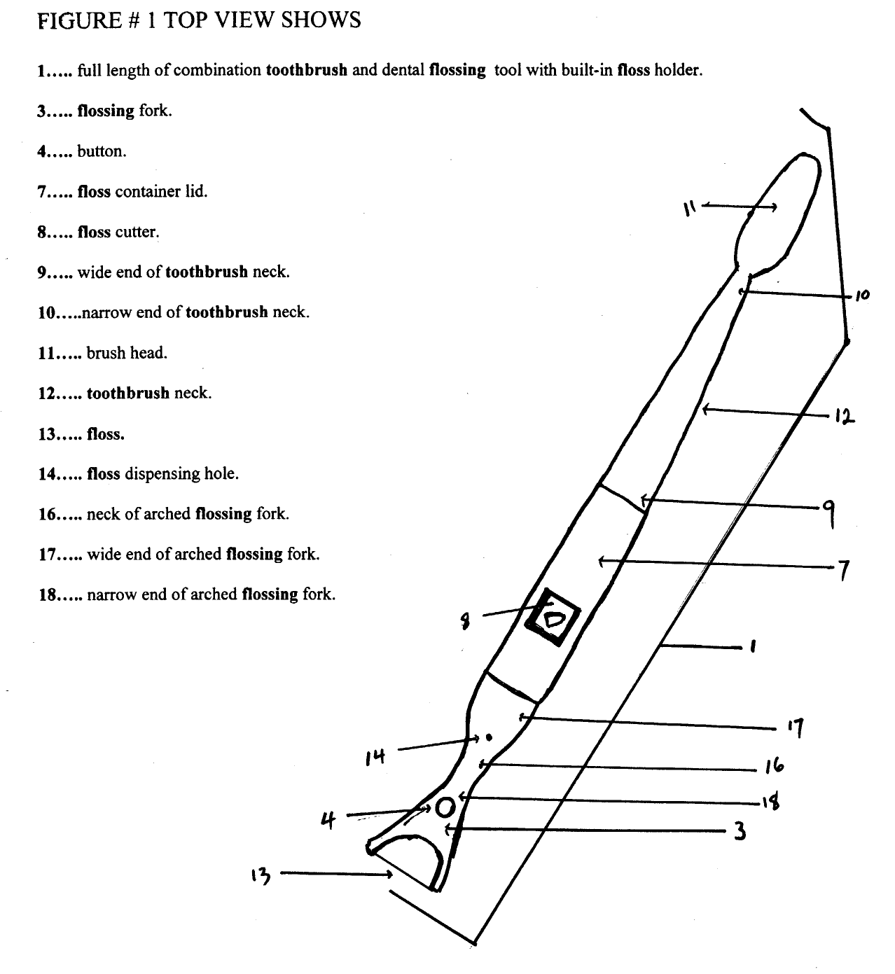

From an overview standpoint, the combination toothbrush and dental flossing tool with built-in floss holder 1 comprises of tapered necks 12 and 16 defining a wide end 9 and 17, and a narrow end 10 and 18. A conventional shaped toothbrush head 11 is integrally or otherwise fixedly secured to the narrow end 10 of the tapered neck 12 and the arched flossing fork 3 is integrally or otherwise fixedly secured to the narrow end 18, as best illustrated in FIG. 1. The toothbrush head 11 is provided with unillustrated bristles which project therefrom and may be utilized by a user to effect brushing and cleaning of her/his teeth. The flossing fork 3 is provided with a section of floss 13 and may be utilized by a user to effect flossing and cleaning of her/his teeth.

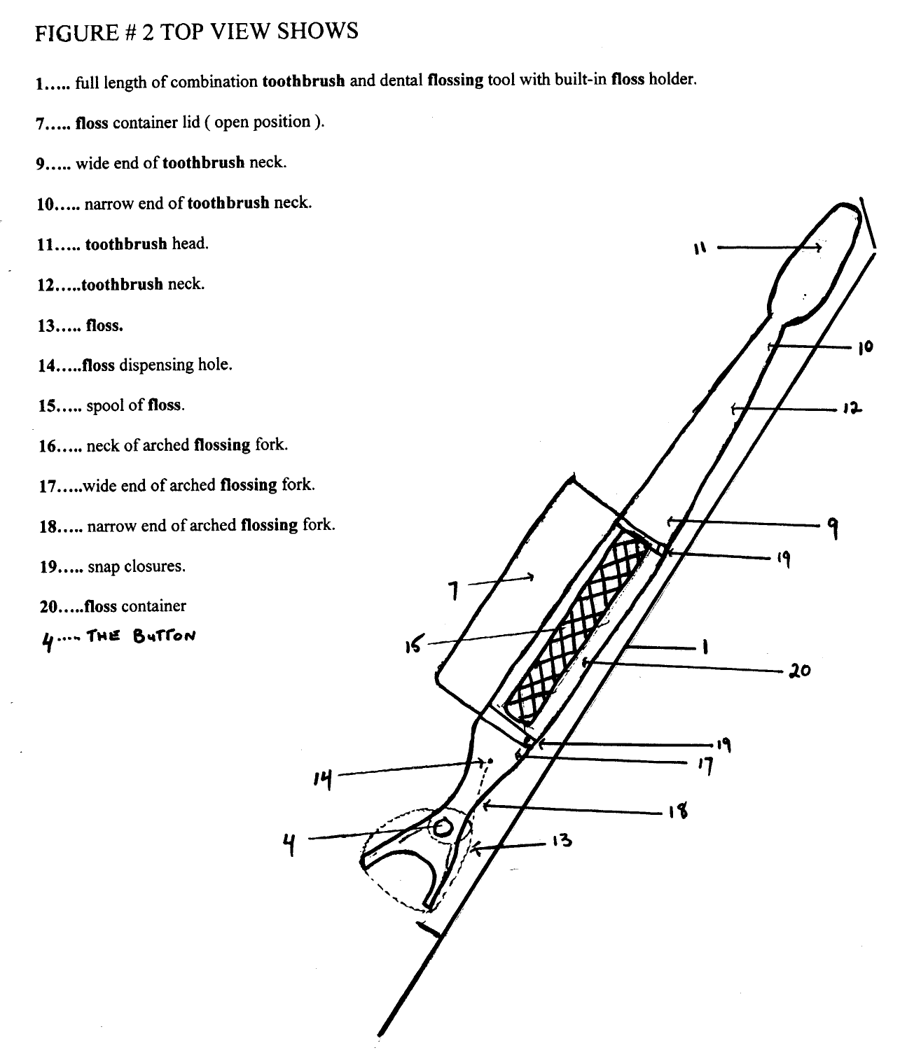

As best illustrated in FIG. 2, a spool holding container 20 is integrally or otherwise fixedly secured to the wide end 9 of the tapered neck 12 and the wide end 17 of the tapered arched neck 16. The spool holding container 20 supports therewithin a dental floss spool 15 formed of conventional waxed or unwaxed floss. Connected to the spool holding container 20 is a floss holding arched flossing fork 3 across which a portion of dental floss 13 may be positioned and held in a taut position for use thereof by the user. The tapered neck 12 and the spool holding container 20, and the floss holding arched flossing fork 3 cooperate to define a toothbrush handle which may be grasped and manipulated by the user to effect movement of the toothbrush head 11 within his/her mouth during use.

In use, the combination toothbrush and dental flossing tool with built-in floss holder 1 provides a convenient means of storing and utilizing dental floss within a toothbrush. The devise 1 allows a user to dispense a length of dental floss 13 from the dental floss spool 15 arrange such a length across the tips of the arched flossing fork 3, whereby flossing of the users teeth may commence.

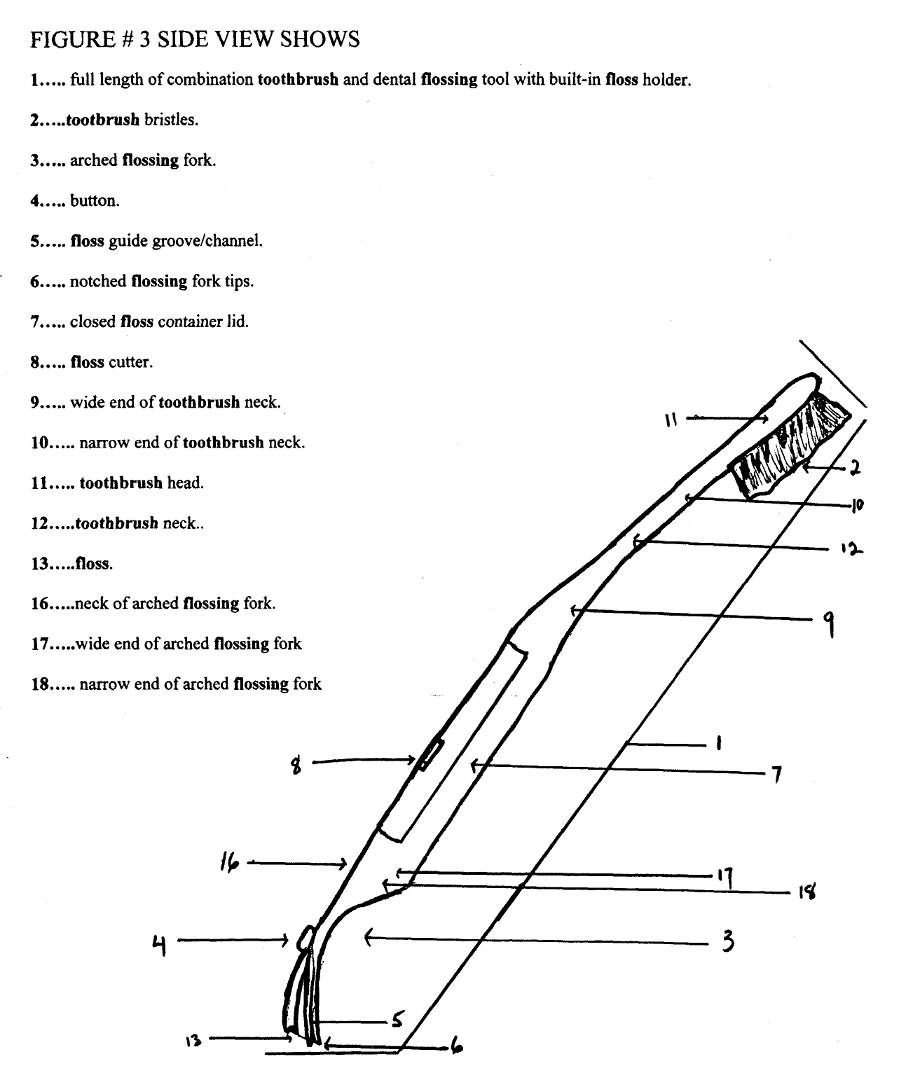

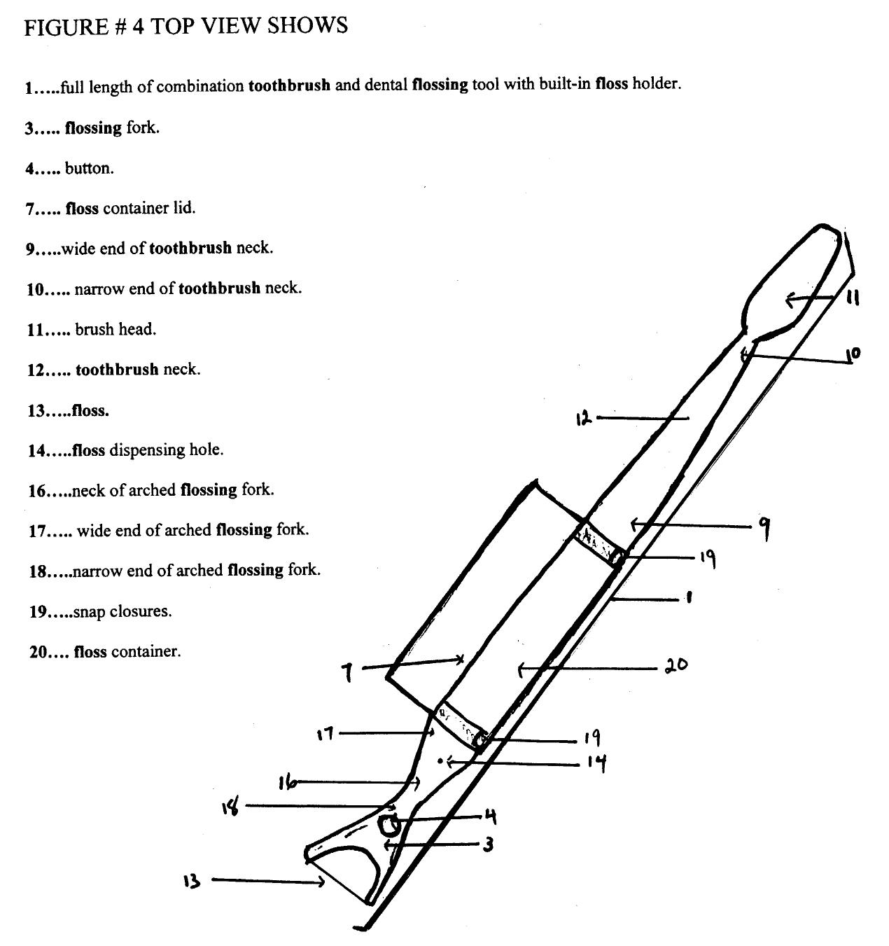

As best illustrated in FIG. 3, a full side view of the combination toothbrush and dental flossing tool with built-in floss holder 1, and bristles 2. The floss guide (groove/channel) 5 allows the floss from the floss container 20, exiting through the dispensing hole 14 as described in FIG. 4 to be easily stretched taut across the notched tips 6 of the arched flossing fork 3 by wrapping the floss twice around the button 4 guide the floss along the channel/groove 5 across notched tips 6 and down the channel/groove 5 to the button 4 wrap twice and down to the cutter 8 where the floss can be readily severed by merely pulling the floss against the cutting section thereof. Concurrently with the cutting action a leading section of floss is left exposed at a position to be conveniently gripped for a later withdrawal of a next length of floss.

As best illustrated in FIG. 4, the snap closures 19 inside the floss container 20 at the top of the wide end 9 of the toothbrush neck 12, and the wide end 17 of the arched flossing fork 3 of the combination toothbrush and dental flossing tool with built-in floss holder

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A combination toothbrush and dental flossing tool with built-in floss holder, comprising
(a) an elongated body member having a brush section at one end, a hollow cylindrical handle, and forked flossing section having a pair of spaced arms at the opposite end.
(b) the brush and neck section having a slight 5-degree downward angle.
(c) a hollow cylindrical handle, where a spool of floss can be inserted.
(d) a snap shut lid to enclose the spool of floss.
(e) a recessed metal floss cutter in the center of the snap shut lid.
(f) a forked floss holder with a 10 degree downward angle, with a button at the base of the fork where the floss is wrapped, and a channel to guide the floss to the notched tips, where the floss is stretched across the tips, and held taut by again wrapping the floss around the button.
